(19) United States
(12) Patent Application Publication
(10) Pub. No.: US 2016/0355124 A1
(43) Pub. Date: Dec. 8, 2016

(54) MOLDED ELECTROLUMINESCENT AUTOMOTIVE INTERIOR COMPONENTS

(71) Applicant: FORD GLOBAL TECHNOLOGIES, LLC, Dearborn, MI (US)

(72) Inventors: Guillermo Cesar Cervantes Guarneros, Atizapan de Zaragoza (MX); Armando Enrique Gutierrez Lopez de Lara, Mexico City (MX)

(21) Appl. No.: 14/730,264

(22) Filed: Jun. 4, 2015

(51) Int. Cl. B60Q 3/02

(52) U.S. Cl. CPC B60Q 3/0283; B60Q 3/0293; B60Q 2500/10

(57) ABSTRACT

An electroluminescent interior trim component for a vehicle includes a shaped electroluminescent polymer film and an interior trim component molded to the shaped film. A controller causes the electroluminescent film to emit a predetermined sequence of light colors and/or light intensities. An actuator is provided for actuating the predetermined sequence. Methods of manufacturing an electroluminescent interior trim component as described include shaping the electroluminescent polymer films to a form defining the desired shape of the automotive trim component, and depositing a suitable substrate on the shaped films to define the trim component body.

### TECHNICAL FIELD

This disclosure relates generally to vehicle ambient lighting and interior trim components. More particularly, the disclosure relates to molded vehicle components including electroluminescent polymers actuated by a users' touch for providing or enhancing vehicle ambient lighting.

### BACKGROUND

Vehicle interior lighting components serve a variety of functional and aesthetic purposes, including general illumination, specific feature illumination, and accent lighting. In providing such lighting, particularly when conventional incandescent lighting is used, considerations of space, power requirements, and thermal management to account for heat emitted from the lighting are paramount. For that reason, alternatives to incandescent lighting have been considered which provide more compact, cooler light sources and which require less power for operation. Once such alternative which has been considered is electroluminescent lighting, such as electroluminescent panels including electroluminescent polymers. It is known to use such panels for backlighting of instrument/dash panel instrumentation, for example.

As is known, electroluminescence is an optical/electrical phenomenon wherein a material emits light in response to passage therethrough of an electrical current or a strong electrical field, causing excited electrons to release energy as photons or light. At a high level, an electroluminescent polymer or film can be provided by sandwiching a phosphor layer between a pair of electrodes. An electrical current established between the electrodes will excite electrons in the phosphor layer, causing emission of light.

A color of the light emitted can be altered by a variety of methods, including by providing color filter layers, by adding dyes to alter the light color emitted, by using different compounds in the phosphor layer to cause emission of a different color, and others. For example, ZnS doped with Mn produces a yellow-orange light when subjected to an electrical current, whereas ZnS doped with copper produces a green light, ZnS doped with silver produces a blue light, etc. Other materials are known for incorporation in the phosphor layer to alter the color emitted. Such electroluminescent technologies provide advantages of low power consumption, reduced heat emission, limited external circuitry requirements, and long life. Existing technology is known to produce very thin electroluminescent polymer films which produce significant light.

Incorporation of such electroluminescent polymer films into automotive trim components and other automotive interior components, while attractive for reasons of reduced power consumption, reduced space requirements, reduced heat emission, etc., present certain challenges. In particular, it is necessary to provide methods for making electroluminescent interior trim components that are compatible with typical automotive manufacturing processes for fabricating such interior trim components, such as low pressure plastic injection molding. A particular goal is to allow incorporation of electroluminescent polymer films into automotive trim components of varying sizes and configurations during manufacture of the trim components.

To solve this and other problems, the present disclosure relates to an electroluminescent automotive trim component, and to methods of making such a component. Advantageously, the described methods integrate well into conventional automotive manufacturing processes for making automotive trim components.

### SUMMARY

In accordance with the purposes and benefits described herein, in one aspect an electroluminescent interior trim component for a vehicle is described, including a shaped electroluminescent polymer film and an interior trim component molded to the shaped film. A controller is provided which causes the electroluminescent film to emit a predetermined sequence of light colors and/or light intensities. An actuator is provided for actuating the predetermined sequence. The described component further includes a power source for supplying an electrical current to the electroluminescent polymer film.

In embodiments, the controller is a microchip including a processor and a memory, and logic including executable instructions to cause the polymer film to emit the predetermined sequence. The power source may be a solar cell embedded in the material of the polymer film, advantageously making the electroluminescent interior trim component substantially self-sustaining.

In another aspect, a method for manufacturing an electroluminescent interior trim component is described. In embodiments, the method includes steps of shaping the electroluminescent polymer films to a form defining the desired shape, geometry, size, cross-sectional profile, etc. of the automotive trim component being manufactured. Typically, the films will include the above-described actuator, power source, etc. prior to the shaping step. Next, a suitable substrate is deposited on the shaped films to define the trim component body.

In the following description, there are shown and described embodiments of the disclosed electroluminescent automotive trim component and methods of making. As it should be realized, the device is capable of other, different embodiments and its several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed electroluminescent automotive trim component and methods of making, and together with the description serve to explain certain principles thereof. In the drawing:

FIG. 1 depicts an electroluminescent trim component according to the present disclosure;

FIG. 2A shows a method for fabricating the electroluminescent trim component of FIG. 1;

FIG. 2B shows a next step of the method of FIG. 2A for fabricating the electroluminescent trim component of FIG. 1;

FIG. 2C shows a next step of the method of FIG. 2A for fabricating the electroluminescent trim component of FIG. 1;

FIG. 2D shows a final step of the method of FIG. 2A for fabricating the electroluminescent trim component of FIG. 1;

FIG. 3A shows an alternative method for fabricating the electroluminescent trim component of FIG. 1;

FIG. 3B shows a next step of the method of FIG. 3A for fabricating the electroluminescent trim component of FIG. 1;

FIG. 3C shows a next step of the method of FIG. 3A for fabricating the electroluminescent trim component of FIG. 1;

FIG. 3D shows a next step of the method of FIG. 3A for fabricating the electroluminescent trim component of FIG. 1;

FIG. 3E shows a next step of the method of FIG. 3A for fabricating the electroluminescent trim component of FIG. 1;

FIG. 3F shows a final step of the method of FIG. 3A for fabricating the electroluminescent trim component of FIG. 1;

FIG. 4A shows a first step of actuation of a preprogrammed color sequence the electroluminescent trim component of FIG. 1;

FIG. 4B shows the electroluminescent trim component cycling through a first color of the color sequence;

FIG. 4C shows the electroluminescent trim component cycling through a second color of the color sequence;

FIG. 4D shows the electroluminescent trim component cycling through a second color of the color sequence;

FIG. 5 shows an alternative embodiment including a connector for supplying external power to the electroluminescent polymer film;

FIG. 6 depicts an alternative embodiment of the electroluminescent trim component of FIG. 1; and

FIG. 7 depicts another alternative embodiment of the electroluminescent trim component of FIG. 1.

Reference will now be made in detail to embodiments of the disclosed electroluminescent automotive trim component, examples of which are illustrated in the accompanying drawing figures.

### DETAILED DESCRIPTION

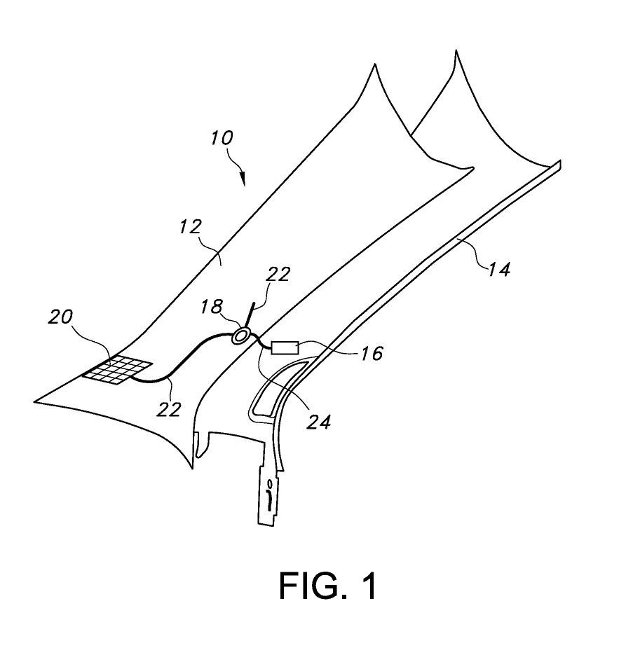

With reference to FIG. 1, an automotive trim component 10 is depicted. The component 10 includes one or more electroluminescent polymer films 12, shaped to conform to the configuration of the desired automotive trim component by methods described infra. As summarized above, a variety of suitable electroluminescent polymer films are known in the art and are contemplated for use herein. In one embodiment, the electroluminescent polymer film 12 is sold under the trade name/trademark LIGHT TAPE (Light Tape Innovations, St. Petersburg, FL). As will be appreciated, one or more sections of electroluminescent polymer film 12 may be arrayed sequentially or may overlap, allowing actuation of the film 12 by an electrical current to emit one or more lights of different colors/intensities, different sequences of light colors/intensities, etc. Suitable mechanisms for providing electroluminescent polymer films 12 emitting different colors have been described supra, such as including providing phosphor layers having different compounds incorporated therein which create different light colors on application of an electrical current.

The component 10 further includes a body 14 having a like shape, geometry, size, cross-sectional profile, etc. to the electroluminescent polymer film 12. In embodiments, body 14 will be manufactured of a plastic or other suitable polymer substrate amenable to molding processes, as is common in the industry for manufacturing automotive trim components.

A controller 16 is included, for causing the electroluminescent polymer films 12 to emit a predetermined sequence of light colors and/or light intensities. In one embodiment, the controller 16 is disposed on a portion of the body 14, providing ease of access for programming/reprogramming, repair or replacement, etc. A variety of controller 16 types having the capacity to store an actuation sequence for electroluminescent polymer films 12 are known in the art and contemplated for use herein. In one embodiment, a microcontroller is provided including at least a processor and a memory, an further having logic including executable instructions for causing the one or more electroluminescent polymer films 12 to emit light in a preprogrammed sequence. As is known, such microcontrollers are configured to interface with computing devices, via which preprogrammed color sequences, intensities, designs, etc. can be programmed and transferred to the microcontroller for subsequent transmission to the electroluminescent polymer film 12.

An actuator 18 is included, for actuating the preprogrammed sequence. Any suitable actuator is contemplated, including a switch, pressure switch, etc. In an embodiment, a capacitive tactile sensor/switch actuator 18 is provided, embedded in at least one of the one or more electroluminescent polymer films 12. As will be appreciated, such an embedded actuator 18 further reduces the space requirements for automotive trim components including the films 12.

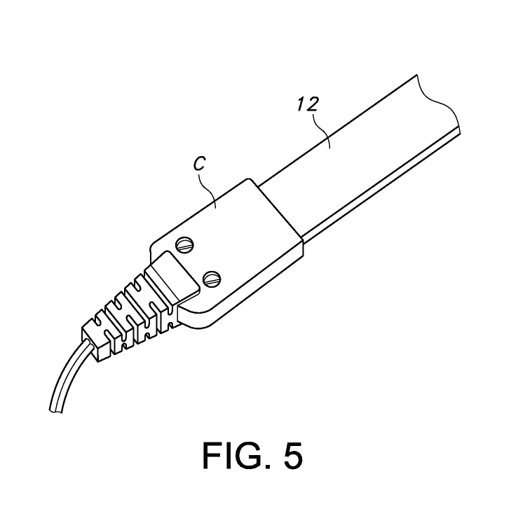

Finally, a power source 20 is provided for supplying an electrical current to the electroluminescent polymer films 12 to cause emission of light. Any suitable power source is contemplated. For example, a connector C may be provided (see FIG. 5) for electrically connecting the polymer films 12 to a power source such as a battery (not shown) associated with the vehicle (not shown) in which the interior trim component 10 is disposed.

In an embodiment (see FIG. 1), power source 12 is a solar cell of substantially conventional construction embedded in the material of electroluminescent polymer films 12. As will be appreciated, this allows providing an electroluminescent automotive trim component 10 which is substantially self-contained in terms of electrical power requirements, rather than diverting electrical power from the motor vehicles electrical system. Wiring 22 transports electrical current supplied by power source 20 to actuator 18 and to an electrode (not shown) of the electroluminescent polymer films 12. A wired connection 24 is provided also to allow communication between controller 16 and the electroluminescent polymer films 12 and transmit the preprogrammed sequence of light colors, light intensities, designs, etc.

A variety of methods for manufacturing the above-described automotive trim component 10 are contemplated. At a high level the methods incorporate shaping the electroluminescent polymer films 12 to a form defining the desired shape, geometry, size, cross-sectional profile, etc. of the automotive trim component 10 being manufactured. Typically, the films 12 will include the above-described actuator 18, power source 20, wiring 22, etc. prior to the shaping step. Next, a suitable substrate is deposited on the shaped films 12 to define the trim component body 14.

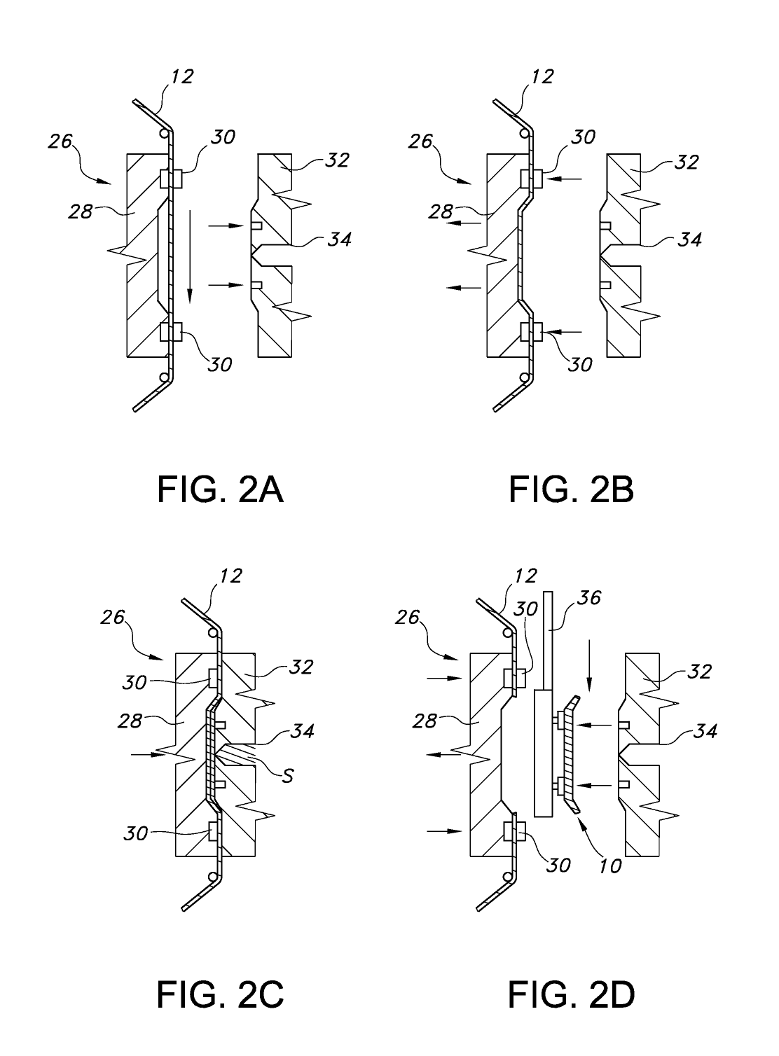

In one embodiment, with reference to FIGS. 2A-2D, a section of electroluminescent polymer film 12 is disposed on a form 26 (FIG. 2A) such as a first portion 28 of a mold for forming an automotive trim component. Next (FIG. 2B), the film 12 is clamped in place by clamps 30 and shaped to correspond to a cross-sectional configuration of the mold 28. In the depicted embodiment, this is accomplished by applying a vacuum to a bottom surface of film 12, causing the film to substantially conform to the shape of the first mold portion 28. It will be appreciated that alternative methods are contemplated, for example by application of a compressed air stream to force the film 12 to conform to the shape of the first mold portion 28. Next (FIG. 2C), a second portion 32 of the mold is disposed above first portion 28 and shaped film 12, and a suitable substrate S is introduced into an interior of form 26, which interior will as is well-known in the art define the exterior shape of the automotive trim component 10. As described above, any suitable substrate is contemplated, including plastics and other polymers, and any other substrate suitable for introducing into a form 26 as described.

In the depicted embodiment, the process is an injection molding process, and the substrate S is introduced by way of aperture 34. After introduction of substrate S and any necessary cooling period, the automotive trim component 10 is ejected from form 26 and removed, such as by a robot arm 36. Excess electroluminescent polymer film 12 can be trimmed and the component 10 can be transferred to a next step in the manufacturing process.

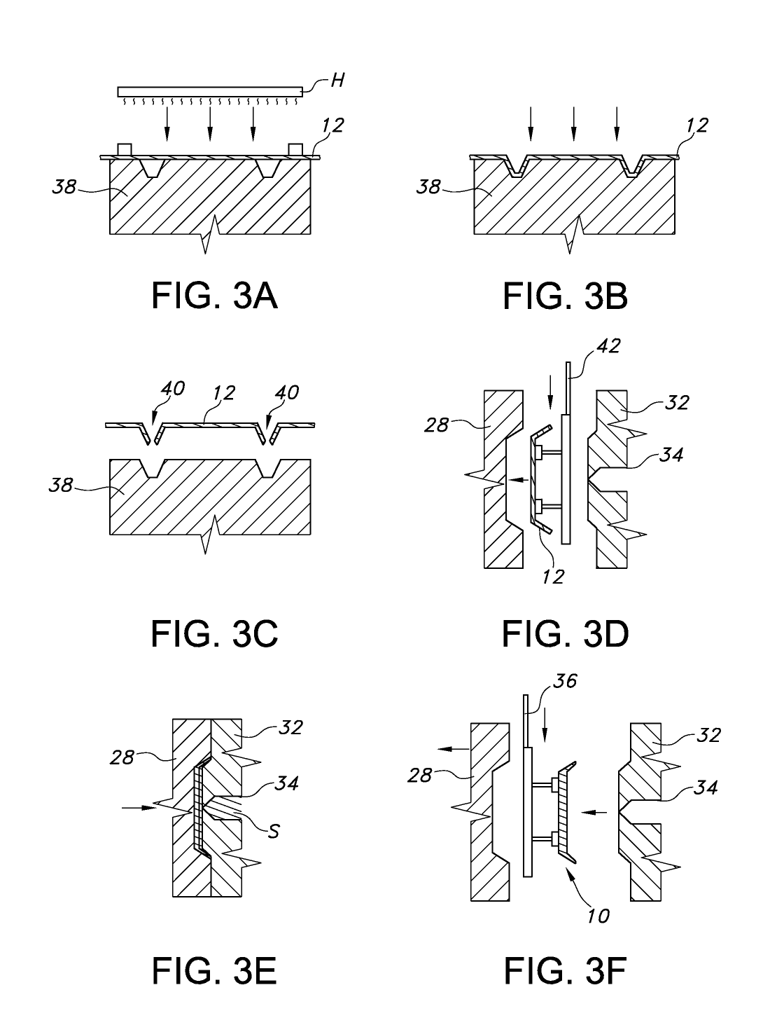

In an alternative embodiment, with reference to FIGS. 3A-3F, electroluminescent polymer film 12 is disposed on a first form 38 defining an internal cross-section corresponding to a desired shape of the automotive trim component 10 (see FIG. 3A). Heat is applied by way of a heat source H, to cause the film 12 to soften and become more malleable. Next (FIG. 3B), film 12 is forced to conform to the shape of the first form 38, such as by vacuum molding or compressed air molding as described above. Superfluous portions of film 12 may be removed, such as by knives 40. Then, the formed and trimmed film 12 is transferred to a second form 42, which may comprise a first mold portion 28 and a second mold portion 32 as described above. The remainder of the fabrication process for automotive trim component 10 is substantially as described above and depicted in FIGS. 2C-D.

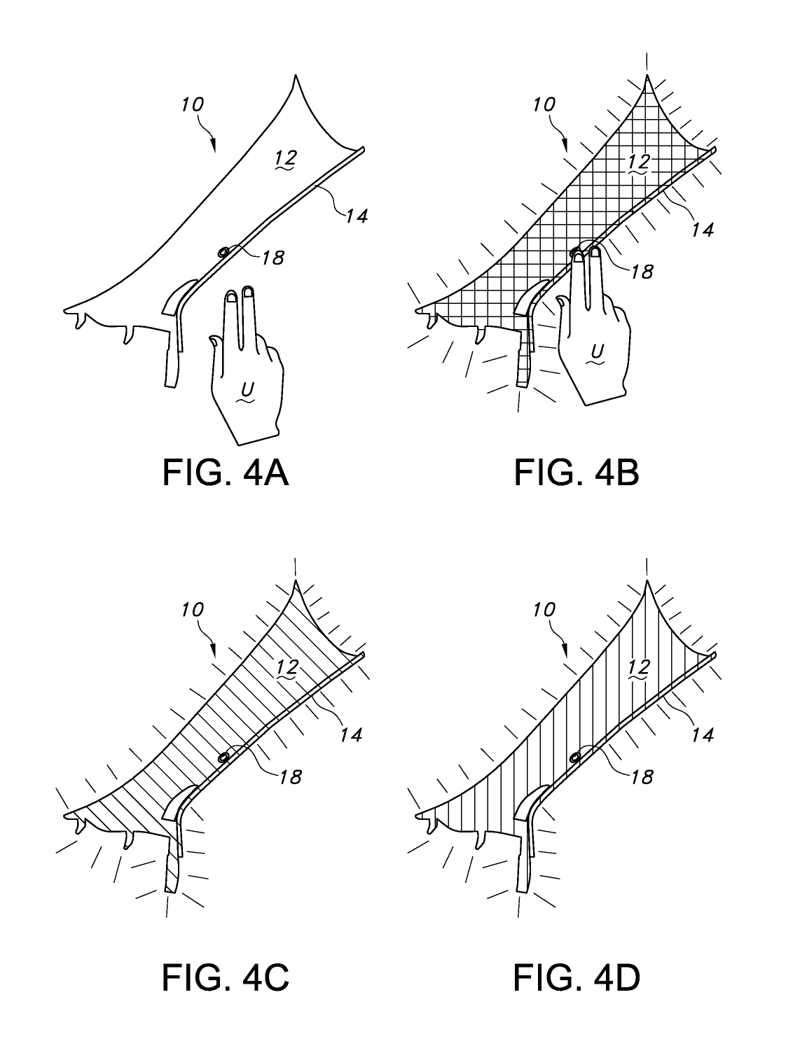

In use, an installed electroluminescent automotive trim component 10 is actuated by a user U by way of actuator 18. On pressing actuator 18 (see FIGS. 4A-B), a preprogrammed sequence determined by controller 16 (not shown in this view) is initiated. In the depicted embodiment, the preprogrammed sequence is a cycle of different light colors emitted by electroluminescent polymer film 12 (see FIGS. 4B-D), with the cycle being initiated by pressing actuator 18 and continuing through a full cycle. Of course, alternative embodiments are contemplated, including having polymer film 12 emit a different color each time actuator 18 is pressed, having polymer film 12 emit one or more different light colors and/or intensities during the completion of the preprogrammed sequence, having polymer film 12 emit one or more different light colors and/or intensities and/or designs during the completion of the preprogrammed sequence, and others. On completion of the preprogrammed sequence, the electroluminescent automotive trim component 10 returns to the original state depicted in FIG. 4A.

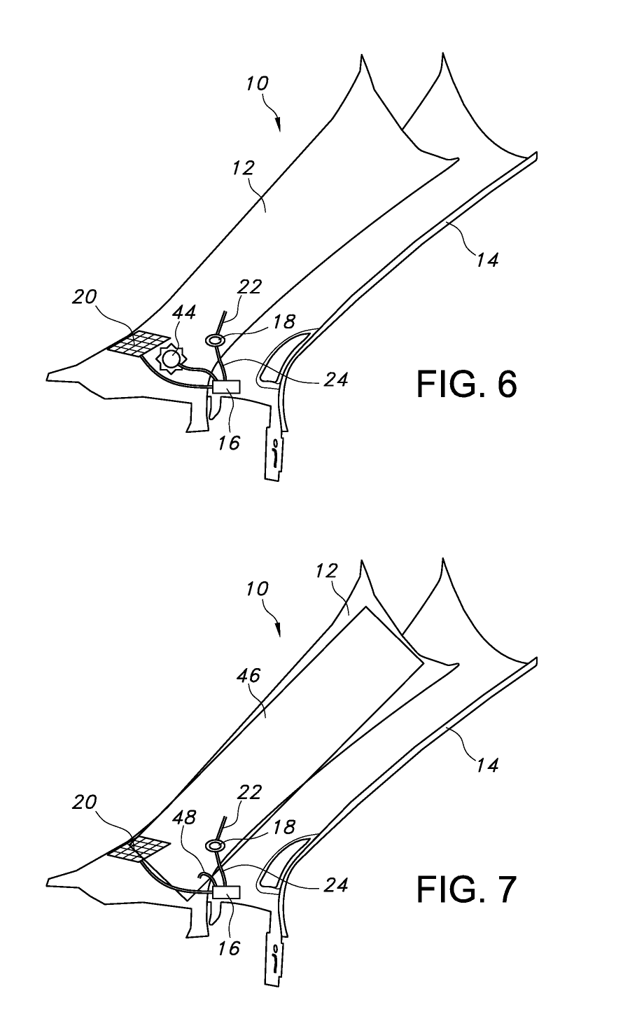

Obvious modifications and variations are possible in light of the above teachings. For example, as shown in FIG. 6, the controller 16 is operatively connected to a light source 44 configured for emitting a range of colors. Such light sources 44 are well-known in the art and do not require extensive discussion herein. However, at a high level it is known to provide light sources 44 which, depending on an actuation sequence applied thereto, will emit a different color. A non-limiting example of such light sources 44 is an RGB LED light source, which as is known is an LED including at least one red, one green, and one blue light source. In combination, such RGB LEDs are capable of emitting any desired color by actuation of the RGB lights in particular combinations/intensities. Thus, particular combinations of the RGB lights of the LED are actuated to produce differing colors and/or intensities, in sequences dictated by controller 16.

In this embodiment, polymer film 12 acts as a light diffuser or “light pipe,” whereby the light/light color emitted by light source 44 is transmitted throughout the polymer film 12. Thus, as programmed into controller 16, any desired predetermined sequence of light colors and/or light intensities can be transmitted by the electroluminescent polymer film 12 of automotive trim component 10. By a user actuating actuator 18, the desired predetermined sequence of light colors and/or light intensities provided by controller 16 is caused to cycle through (see FIGS. 4A-4D).

In yet another alternative embodiment (see FIG. 7), at least a portion of electroluminescent polymer film 12 comprises a flexible light-emitting film 46 which includes an emissive electroluminescent layer which emits light in different colors/patterns in accordance with an electric current frequency applied thereto. Alternatively, flexible light-emitting film 46 may be directly disposed on substrate 14. A thermoformed polymer layer (not shown for convenience) may cover the flexible light emitting film 46 to reduce the risk of damage thereto. Such technology is known in the art, for example for use in high resolution television screens. As such, a detailed explanation is not required herein. However, at a high level such light emitting films 46 include a plurality of light sources, each acting as pixels in combination to emit particular light colors and patterns including combinations which create predetermined designs and/or images. As shown, flexible light emitting film 46 may be operatively connected to controller 16 by a wiring return 48.

In one non-limiting embodiment, flexible light-emitting film 46 comprises organic LEDs (OLEDs). As is known, OLEDs are light-emitting diodes which can be incorporated into flexible films similar in structure to the electroluminescent polymer films described above and having an emissive electroluminescent layer comprising a film of an organic compound which emits light in response to an electric current. Multiple organic compound layers may be included to improve efficiency. The organic compound film layer(s) is disposed between two electrodes, one of which is typically transparent or substantially transparent. Application of a voltage between the electrodes (anode and cathode) causes the organic compound(s) to emit radiation whose frequency is in the visible region. A variety of OLEDs are known, including small molecule OLEDs (SM-OLEDs) comprising organometallic chelates, fluorescent and phosphorescent dyes, and conjugated dendrimers to create different light colors/patterns. Polymer OLEDs (PLEDs) are also known which comprise electroluminescent conductive polymers that emit light when connected to an external voltage. Exemplary conductive polymers include poly(p-phenylene vinylene) derivatives, polyfluorene, and others. Substitution of side chains onto the polymer backbone may be used to determine the emitted light color for a particular PLED. Still more, phosphorescent OLEDs are known comprising a polymer doped with an organometallic complex. Examples include poly(N-vinylcarbazole) doped with iridium complexes, poly(N-vinylcarbazole) doped with heavy metals such as platinum, and others.

Regardless, as is known such OLEDs can be combined to provide what is essentially an LED screen disposed on electroluminescent polymer film 12 and/or on plastic substrate 14, which under the control of controller 16 can be caused to emit a predetermined sequence of light colors, light patterns, or even particular designs/images (similar in principle to the use of the technology to create images on television screens). As programmed into controller 16, any desired predetermined sequence of light colors and/or light intensities and/or images/designs can be emitted by the flexible light-emitting film 46 of automotive trim component 10. By a user actuating actuator 18, the desired predetermined sequence of light colors/light intensities/images/designs provided by controller 16 is caused to cycle through (see FIGS. 4A-4D).

All such modifications and variations are within the scope of the appended claims when interpreted in accordance with the breadth to which they are fairly, legally and equitably entitled.

What is claimed:

1. An actuable electroluminescent interior trim component for a vehicle, comprising:
one or more shaped electroluminescent polymer films;
an interior trim component molded to the one or more shaped electroluminescent polymer films;
a controller configured to cause the one or more shaped electroluminescent polymer films to emit a predetermined sequence of light colors and/or light intensities; and
an actuator for actuating the predetermined sequence.

2. The component of claim 1, further including a power source for providing an electrical current to the one or more shaped electroluminescent polymer films.

3. The component of claim 1, wherein the controller is a microchip including at least a processor and memory and provided with logic including executable instructions to cause the one or more shaped electroluminescent polymer films to emit the sequence.

4. The component of claim 1, wherein the actuator is a tactile sensor embedded in the one or more shaped electroluminescent polymer films.

5. The component of claim 2, wherein the power source is a solar cell embedded in in the one or more shaped electroluminescent polymer films.

6. The component of claim 1, wherein the interior trim component is injection molded to a form holding the one or more shaped electroluminescent polymer films.

7. A vehicle interior trim part including the component of claim 1.

8. A vehicle including the component of claim 1.

9. An actuable electroluminescent interior trim component for a vehicle, comprising:
one or more shaped electroluminescent polymer films;
an interior trim component molded to the one or more shaped electroluminescent polymer films;
a controller configured to cause the one or more shaped electroluminescent polymer films to emit a predetermined sequence of light colors and/or light intensities; and
a tactile switch embedded in the one or more shaped electroluminescent polymer films for actuating the predetermined sequence.

10. The component of claim 9, further including a power source for providing an electrical current to the one or more shaped electroluminescent polymer films.

11. The component of claim 9, wherein the controller is a microchip including at least a processor and memory and provided with logic including executable instructions to cause the one or more shaped electroluminescent polymer films to emit the sequence.

12. The component of claim 10, wherein the power source is a solar cell embedded in the one or more shaped electroluminescent polymer films.

13. The component of claim 9, wherein the interior trim component is injection molded to a form holding the one or more shaped electroluminescent polymer films.

14. A vehicle interior trim part including the component of claim 9.

15. A vehicle including the component of claim 9.

16. A method for providing an actuable electroluminescent interior trim component for a vehicle, comprising:
shaping one or more electroluminescent polymer films to a desired interior trim component shape;
depositing a substrate on the one or more shaped electroluminescent polymer films to define an interior trim component;
providing a controller configured to cause the one or more shaped electroluminescent polymer films to emit a predetermined sequence of light colors and/or light intensities; and
providing an actuator embedded in the one or more shaped electroluminescent polymer films for actuating the predetermined sequence.

17. The method of claim 16, further including providing a power source for providing an electrical current to the one or more shaped electroluminescent polymer films.

18. The method of claim 16, including providing a microchip controller including at least a processor and memory and logic including executable instructions to cause the one or more shaped electroluminescent polymer films to emit the sequence.

19. The method of claim 16, including providing a tactile sensor actuator embedded in the one or more shaped electroluminescent polymer films.

20. The method of claim 17, including providing a solar cell power source embedded in the one or more shaped electroluminescent polymer films.

21. The method of claim 9, including injection molding the substrate in a form holding the one or more shaped electroluminescent polymer films to define the interior trim component.
